(19) United States
(12) Patent Application Publication
(10) Pub. No.: US 2013/0061868 A1
(43) Pub. Date: Mar. 14, 2013

(54) FOLDABLE FLOSS PICK

(71) Applicant: CHING-AN CHUANG, TAIPEI (TW)

(72) Inventor: CHING-AN CHUANG, TAIPEI (TW)

(21) Appl. No.: 13/424,619

(22) Filed: Mar. 20, 2012

(30) Foreign Application Priority Data
Sep. 9, 2011 (TW) 100217007

(51) Int. Cl. A61C 15/04

(52) U.S. Cl. 132/323

(57) ABSTRACT

A foldable floss pick includes a grip having a first connection section at one end and a floss arch having a second connection section rotatably connected to the first connection section of the grip. A dental floss is connected between two ends of the floss arch. The floss arch defines a virtual face. When not folded, the floss arch is positioned in a first relative position where the virtual face is substantially coplanar with the grip and the floss pick is in a straight form to facilitate package. In use, the floss arch is first folded toward the grip and fixed in a second relative position by means of a latch structure disposed between the grip and the floss arch. Then a user can conveniently use the folded floss pick to clean the teeth.

### BACKGROUND OF THE INVENTION

Field of the Invention

The present invention relates to a foldable floss pick, which can be packaged in a straight flat form. In use, the floss arch is first folded toward the grip and fixed in a position normal to the grip. Then a user can conveniently use the folded floss pick to clean the teeth.

Description of the Prior Arts

Thanks to school teaching and media advocacy, the public hygienic awareness is promoted. Therefore, in addition to various toothbrushes, floss picks have been more and more popularly used to clean off the food residuals deeply trapped in chinks between the teeth. In this case, the teeth can be more thoroughly cleaned up.

FIG. 1 shows a first type of conventional floss pick. The pick body of the conventional floss pick is integrally formed. Such floss pick has a floss holder 60 at one end. A dental floss 61 is connected between two ends of the floss holder 60. When cleaning up the chink between the teeth, a user holds the pick body 62 and extends the dental floss 61 into the chink to clean off the food residuals. However, the dental floss 61 is directed in the same direction as the pick body 62. Therefore, when cleaning up the chink between the teeth on rear side of the oral cavity, the user needs to open his/her mouth wide to extend the dental floss 61 into the chink. It is quite inconvenient and unbecoming to use such kind of floss pick.

FIG. 2 shows a second type of conventional floss pick for solving the above problem. The floss pick has a floss holder 70 formed at one end of the pick body 72. The floss holder 70 is perpendicular to the pick body 72 so that a user can extend the dental floss 71 into the chink between the teeth on rear side of the oral cavity and clean up the chink without opening his/her mouth wide. However, the floss holder 70 is perpendicular to the pick body 71 so that the floss pick is not a plane body and is hard to package for sale.

FIG. 3 shows a third type of conventional separable floss pick. The floss pick includes a floss holder 80 and a pick body 81. The floss holder 80 is detachably assembled with the pick body 81. The floss holder 80 has a first connection section 83. Two lateral arms 84 respectively extend from two ends of the first connection section 83 in the same direction. A dental floss 85 is connected between the terminations of the lateral arms 84. The pick body 81 has a second connection section 86 at one end for connecting with the first connection section 83 to form the floss pick. When packaged, the pick body 81 and the floss holder 80 are separated from each other to facilitate package and sale. In use, the pick body 81 and the floss holder 80 are assembled. When assembled, a user needs to use both hands to hold the pick body 81 and the floss holder 80, which have been sterilized and aseptically automatically packaged in manufacturing process. No matter how the user washes his/her hands prior to use, the hands of the user will still inevitably carry bacteria. As a result, when assembling the pick body 81 with the floss holder 80, both the pick body 81 and the floss holder 80 will be inevitably contaminated by the user's hands.

### SUMMARY OF THE INVENTION

It is therefore a primary object of the present invention to provide a foldable floss pick, which is packaged in a flat form to facilitate package and overcome the shortcoming existing in the second type of conventional floss pick.

It is a further object of the present invention to provide the above foldable floss pick, which is free from assembling process. In use, a user can first fold the floss arch toward the grip and then tear off the packaging paper bag to take out the folded floss pick. In this case, the floss pick is fully prevented from being contaminated by the user's hands so that the problem of contamination of the pick body 81 and the floss holder 81 that exists in the third type of conventional separable floss pick can be eliminated.

To achieve the above and other objects, the foldable floss pick of the present invention includes a grip and a floss arch.

The grip has a first connection section at one end. A dental floss is connected between two ends of the floss arch. A base of the floss arch has a second connection section rotatably connected to the first connection section of the grip. The floss arch defines a virtual face. When not folded, the floss arch is positioned in a first relative position where the virtual face is substantially coplanar with the grip. When folded, the floss arch is positioned in a second relative position where the virtual face is non-coplanar with the grip.

The above foldable floss pick further includes a latch structure. The latch structure includes a first latch section and a second latch section. The first latch section is disposed on the grip in adjacency to the first connection section. The second latch section is disposed on the floss arch in adjacency to the second connection section. The second latch section can be latched with the first latch section to fix the floss arch in the second relative position.

In the above foldable floss pick, the first and second connection sections are slopes. The edges of the first and second connection sections are integrally rotatably connected. When the first and second connection sections are attached to each other, the floss arch is positioned in the second relative position where the second latch section is latched with the first latch section to fix the floss arch in the second relative position.

In the above foldable floss pick, one of the first and second latch sections has the form of an engagement hook for securely fixing the floss arch in the second relative position.

In the above foldable floss pick, the dental floss has a length more than 1.05 times the width of the floss arch, whereby the dental floss can snugly attach to the arcuate surface of a tooth in an arcuate form.

According to the above, in comparison with the conventional floss pick, the foldable floss pick of the present invention has the following advantages:

1. The foldable floss pick of the present invention is packaged in a flat form. Therefore, in a factory, the floss picks can be aseptically packaged with paper bags and stacked and then contained in a box. Accordingly, it is convenient to package the floss picks.

2. In use of the foldable floss pick, after partially tearing off the paper bag, a user can draw out the pointed end of the floss pick and then fold the floss arch and fix the floss arch in the second relative position through the paper bag. Then the user can take out the folded floss pick for cleaning the teeth without contaminating the floss pick.

3. The dental floss of the foldable floss pick can be loosely connected between two ends of the floss arch or tensely connected between two ends of the floss arch to facilitate cleaning of the teeth.

The present invention can be best understood through the following description and accompanying drawings, wherein:

### BRIEF DESCRIPTION OF THE DRAWINGS

FIG. 1 is a perspective view of a first type of conventional floss pick;

FIG. 2 is a perspective view of a second type of conventional floss pick;

FIG. 3 is a perspective view of a third type of conventional separable floss pick;

FIG. 4 is a perspective view of the foldable floss pick of the present invention in a not folded state;

FIG. 5 is a sectional view taken along line 5-5 of FIG. 4;

FIG. 6 is a sectional view taken along line 6-6 of FIG. 4;

FIG. 7 is a perspective view of the foldable floss pick of the present invention in a folded state;

FIG. 8 is a sectional view taken along line 8-8 of FIG. 7; and

FIG. 9 is a sectional view taken along line 9-9 of FIG. 7.

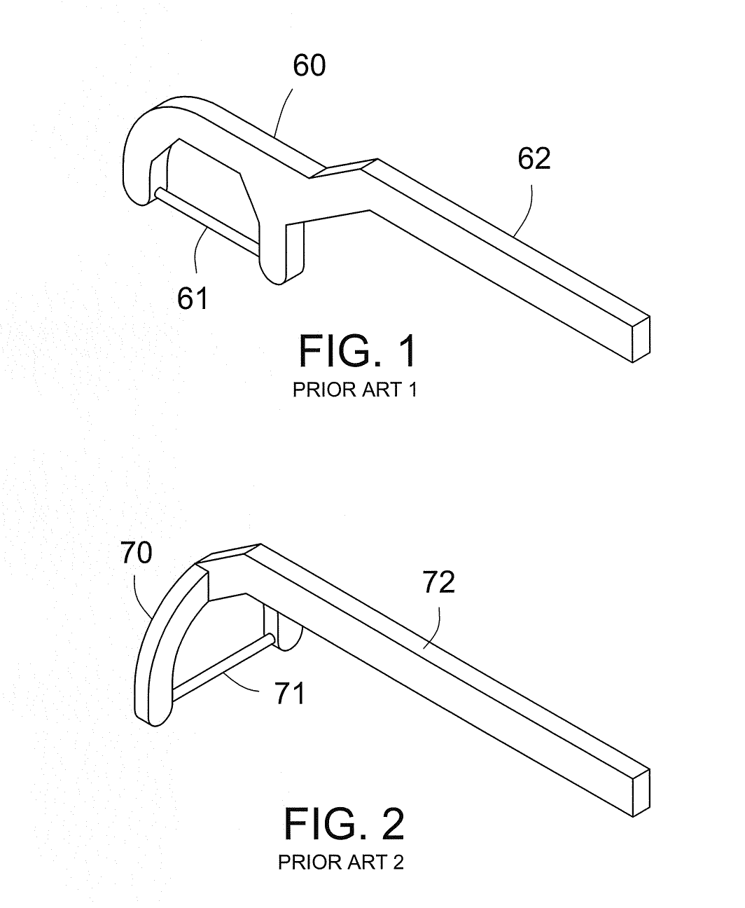

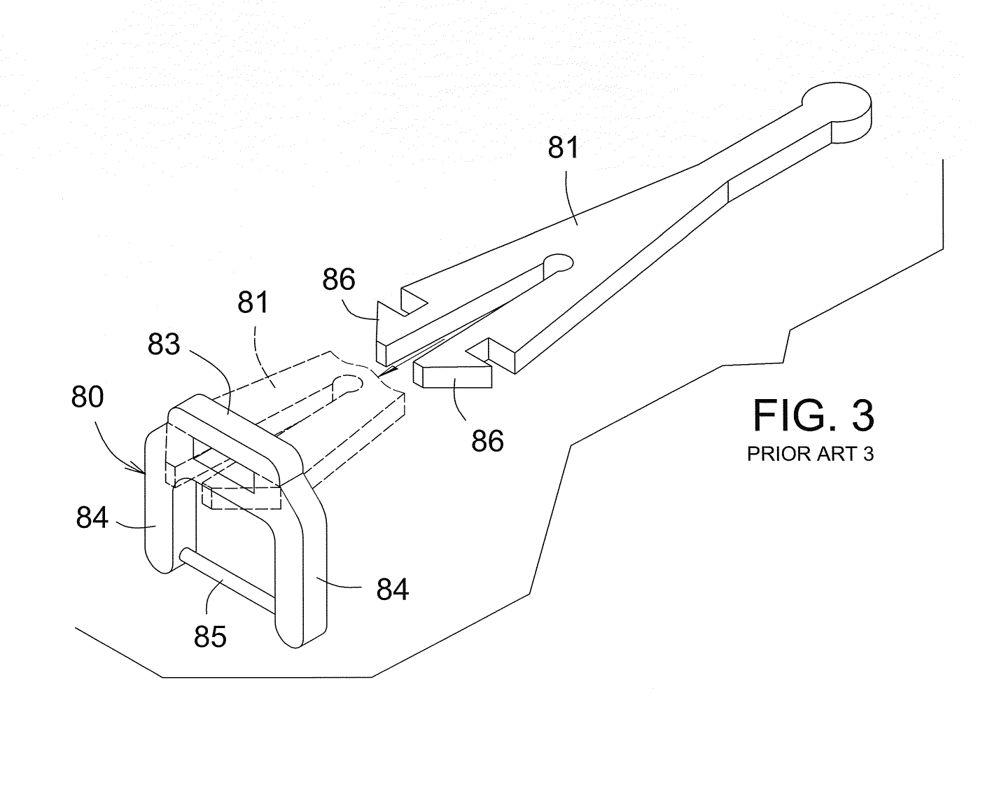

### DETAILED DESCRIPTION OF THE PREFERRED EMBODIMENTS

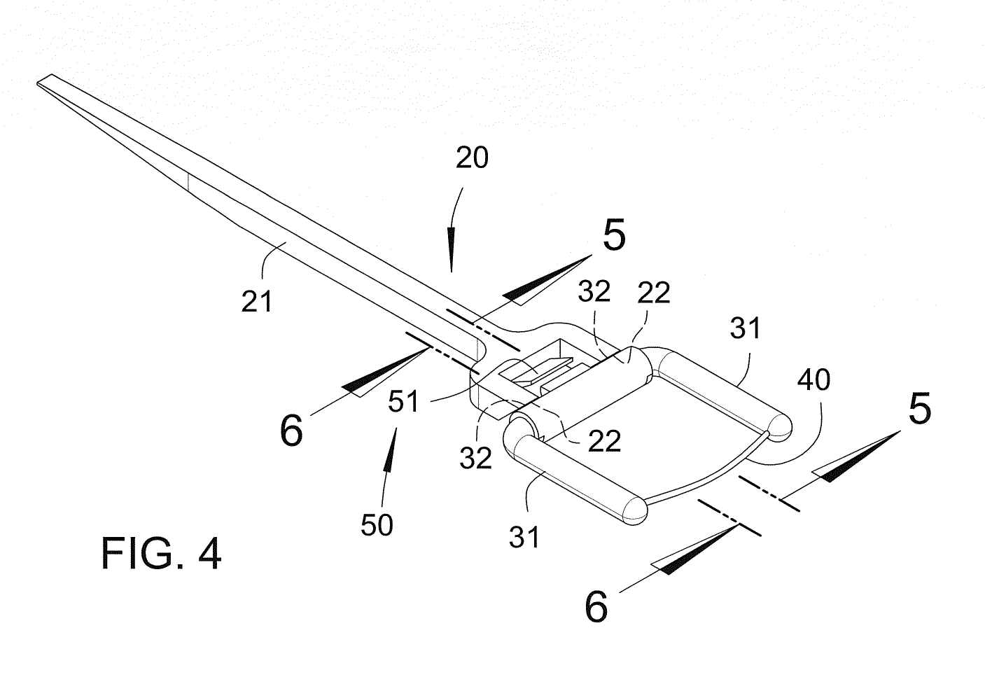

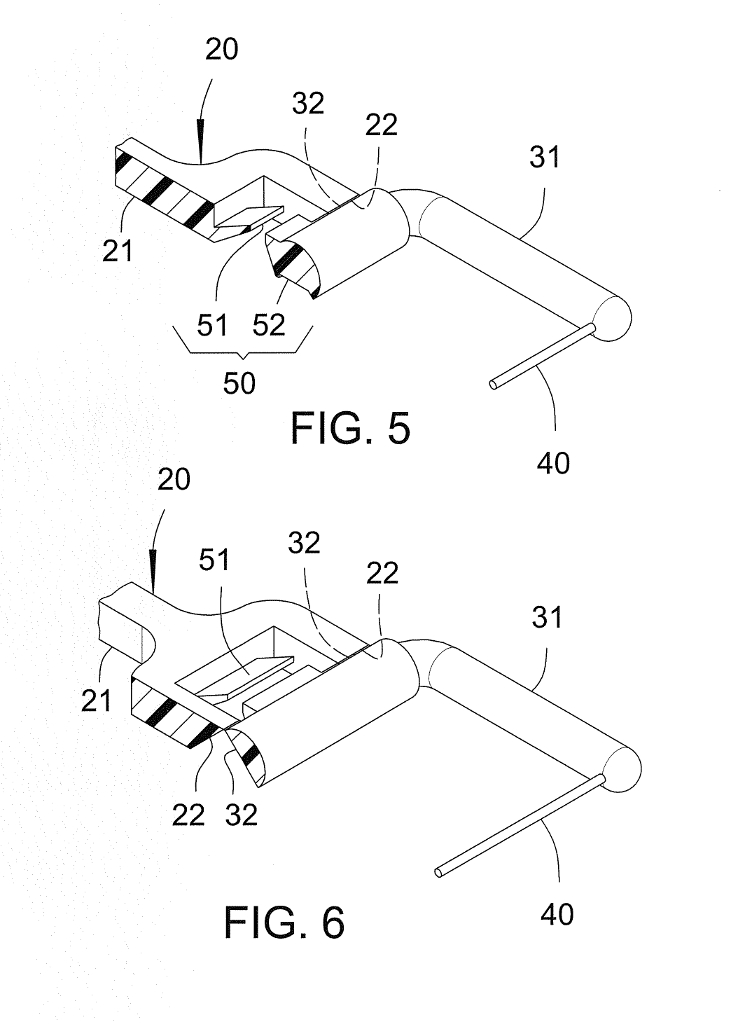

Please refer to FIGS. 4 to 6. The foldable floss pick 20 of the present invention includes a grip 21 and a floss arch 31.

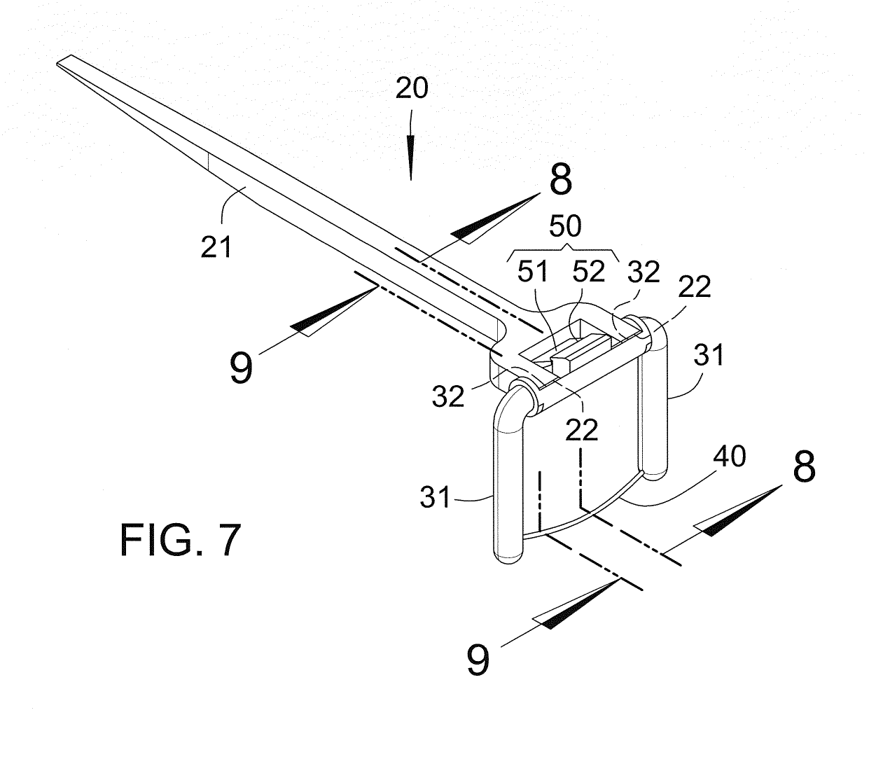

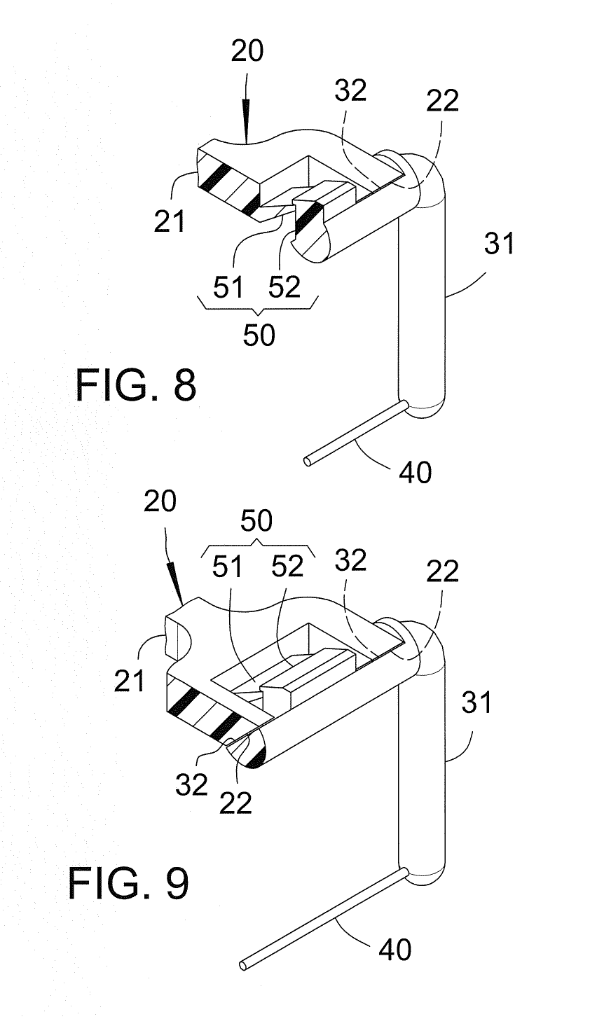

The grip 21 has a first connection section 22 at one end. A dental floss 40 is connected between two ends of the floss arch 31. A base of the floss arch 31 has a second connection section 32. The second connection section 32 is rotatably connected to the first connection section 22 of the grip 21. The floss arch 31 defines a virtual face. When not folded, the floss arch 31 is positioned in a first relative position where the virtual face is substantially coplanar with the grip 21 (as shown in FIGS. 4, 5 and 6). When folded, the floss arch 31 is positioned in a second relative position where the virtual face is non-coplanar with the grip 21 (as shown in FIGS. 7, 8 and 9).

The foldable floss pick 20 of the present invention further includes a latch structure 50. The latch structure 50 includes a first latch section 51 and a second latch section 52. The first latch section 51 is disposed on the grip 21 in adjacency to the first connection section 22. The second latch section 52 is disposed on the floss arch 31 in adjacency to the second connection section 32. The second latch section 52 can be latched with the first latch section 51 to fix the floss arch 31 in the second relative position.

The first and second connection sections 22, 32 are slopes. The edges of the first and second connection sections 22, 32 are integrally rotatably connected. When the first and second connection sections 22, 32 are attached to each other, the floss arch 31 is positioned in the second relative position where the second latch section 52 is latched with the first latch section 51 to fix the floss arch 31 in the second relative position.

One of the first and second latch sections 51, 52 has the form of an engagement hook for securely fixing the floss arch 31 in the second relative position.

The dental floss 40 has a length more than 1.05 times the width of the floss arch 31, whereby the dental floss 40 can snugly attach to the arcuate surface of a tooth in an arcuate form. Alternatively, the dental floss 40 can be fixedly connected between two ends of the floss arch 31 in a tensioned state. The state of the dental floss 40 is not limited.

As shown in FIG. 4, the grip 21 and the floss arch 31 are rotatably connected and coplanar with each other. Accordingly, in a factory, the floss picks 20 can be aseptically packaged with paper bags (not shown) and stacked and then contained in a box.

In use, before tearing off the paper bag, a user can first fold the floss arch 31 toward the grip 21 and fix the floss arch 31 in the second relative position. Then the user can tear off the paper bag to take out the folded floss pick as shown in FIG. 7 for cleaning the teeth.

The above embodiments are only used to illustrate the present invention, not intended to limit the scope thereof. Many modifications of the above embodiments can be made without departing from the spirit of the present invention.

What is claimed is:

1. A foldable floss pick comprising:
(a) a grip having a first connection section at one end;
(b) a floss arch, a dental floss being connected between two ends of the floss arch, a base of the floss arch having a second connection section, the second connection section being rotatably connected to the first connection section of the grip, the floss arch defining a virtual face, when not folded, the floss arch being positioned in a first relative position where the virtual face is substantially coplanar with the grip, when folded, the floss arch being positioned in a second relative position where the virtual face is non-coplanar with the grip; and
(c) a latch structure including a first latch section disposed on the grip in adjacency to the first connection section and a second latch section disposed on the floss arch in adjacency to the second connection section, whereby the second latch section can be latched with the first latch section to fix the floss arch in the second relative position.

2. The foldable floss pick as claimed in claim 1, wherein the first and second connection sections are slopes, an edge of the first connection section and an edge of the second connection section being integrally rotatably connected, when the first and second connection sections are attached to each other, the floss arch being positioned in the second relative position where the second latch section is latched with the first latch section to fix the floss arch in the second relative position.

3. The foldable floss pick as claimed in claim 1, wherein one of the first and second latch sections has the form of an engagement hook for securely fixing the floss arch in the second relative position.

4. The foldable floss pick as claimed in claim 1, wherein the dental floss has a length more than 1.05 times a width of the floss arch, whereby the dental floss can snugly attach to an arcuate surface of a tooth in an arcuate form.

5. The foldable floss pick as claimed in claim 2, wherein the dental floss has a length more than 1.05 times a width of the floss arch, whereby the dental floss can snugly attach to an arcuate surface of a tooth in an arcuate form.

6. The foldable floss pick as claimed in claim 3, wherein the dental floss has a length more than 1.05 times a width of the floss arch, whereby the dental floss can snugly attach to an arcuate surface of a tooth in an arcuate form.
